(19) United States
(12) Patent Application Publication
(10) Pub. No.: US 2018/0064270 A1
(43) Pub. Date: Mar. 8, 2018

(54) SMART CUP, AND METHOD AND SYSTEM THEREFOR FOR PERFORMING COMMAND CONTROL VIA GESTURE

(71) Applicant: BOWHEAD TECHNOLOGY (SHANGHAI) CO., LTD., Shanghai (CN)

(72) Inventors: Gang ZHANG, Shanghai (CN); Rui XU, Shanghai (CN); Yizhen JIANG, Shanghai (CN); Chih-chiang CHIANG, Taipei (TW)

(21) Appl. No.: 15/557,487

(22) PCT Filed: Jan. 18, 2016
(86) PCT No.: PCT/CN2016/071167

§ 371 Date: Sep. 12, 2017

(30) Foreign Application Priority Data
Mar. 17, 2015 (CN) 201510116955.8

(51) Int. Cl. A47G 19/22; G06F 3/01

(52) U.S. Cl. CPC A47G 19/2205; G06F 3/017

(57) ABSTRACT

A method for a smart cup for performing command control via a gesture, comprising: a tilt angle sensor (121) detects an included angle θ between a smart cup and a vertical direction and an included angle α between the smart cup and a preset horizontal reference line in real time, and sends data about the included angles to a control unit (122); the control unit (122) calculates changes in the angles according to the data about the included angles, and recognizes a corresponding gesture according to the changes in the angles; and the control unit (122) matches and executes a corresponding command according to the gesture.

### BACKGROUND OF THE INVENTION

The present invention belongs to the field of smart cup, particularly relates to a smart cup, and method and system therefor for performing command control via gesture.

With the arrival of the mobile era, under the development trend of the Internet of Everything and smart-everything era, smart products are getting increasingly popular among people. They can bring convenience to our lives, work, entertainment and many other aspects. Smart cups designed for drinking water healthily are also gradually in the spotlight.

Similar to smart phones, when using smart cups, it is necessary to control the smart cup by a command. However, unlike smart phones, smart cups do not have a keyboard or a touch screen due to design constraints. There is no human-computer interaction and users cannot communicate a command to the smart cup.

### BRIEF SUMMARY OF THE INVENTION

For this reason, to solve the above-mentioned technical problems, a smart cup, and method and system therefor for performing command control via gesture are provided.

In order to solve the above-mentioned technical problems, the present invention adopts the technical scheme as follows:

A smart cup comprises a cup body and a main board; the main board is provided on a bottom of the cup body and is provided with a tilt angle sensor and a control unit. The tilt angle sensor and the control unit are connected.

The present scheme also relates to a method for a smart cup for performing command control via gesture, comprising:

a tilt angle sensor detects an included angle θ between the smart cup and a vertical direction and an included angle α between the smart cup and a preset horizontal reference line in real time, and sends data about the included angles to a control unit;

the control unit calculates changes in the angles according to the data about the included angles, and recognizes a corresponding gesture according to the changes in the angles;

the control unit matches and executes a corresponding command according to the gesture.

The corresponding gesture recognized according to the changes in the angles comprises:

if the included angle θ shows a regular wave-shaped pattern, the corresponding gesture is horizontal shaking of the cup;

if the included angle θ is always maintained at an angle and the included angle α shows a regular wave-shaped pattern, the corresponding gesture is rotation of the cup;

if the included angle α is always maintained at 270 degrees, the corresponding gesture is turning of the cup upside down.

Corresponding data of the gestures and commands are stored in the control unit.

The present scheme also relates to a system for a smart cup for performing command control via gesture, comprising:

an acquisition unit for data about the included angles for detecting an included angle θ between the smart cup and a vertical direction and an included angle α between the smart cup and a horizontal direction in real time by a tilt angle sensor, and sending data about the included angles to a control unit;

a gesture recognition unit for calculating changes in the angles according to the data about the included angles and recognizing a corresponding gesture according to the changes in the angles by the control unit;

a command control unit for matching and executing a corresponding command according to the gesture by the control unit.

The corresponding gesture recognized according to the changes in the angles comprising:

if the included angle θ shows a regular wave-shaped pattern, the corresponding gesture is horizontal shaking of the cup;

if the included angle θ is always maintained at an angle and the included angle α shows a regular wave-shaped pattern, the corresponding gesture is rotation of the cup;

if the included angle α is always maintained at 270 degrees, the corresponding gesture is turning of the cup upside down.

Corresponding data of the gestures and commands are stored in the control unit.

The present invention, by taking changes in included angles between a smart cup and a vertical direction as well as between the smart cup and a horizontal direction as a basis for recognizing a gesture, enabling different gestures to match different commands, and controlling the smart cup via a command, realizes interaction between an individual and the cup.

### BRIEF DESCRIPTION OF THE DRAWINGS

The present invention is further described in detail below with reference to the accompanying drawings and specific embodiments.

FIG. 1 is a structural schematic diagram of the smart cup of the present invention;

FIG. 2 is a flow chart of a method for a smart cup for performing command control via gesture of the present invention;

FIG. 3 is a schematic diagram of the included angles between a smart cup and a vertical direction as well as between the smart cup and a horizontal direction of the present invention;

FIG. 4 is a curve diagram showing changes in the included angle θ of the horizontal shaking gesture of the present invention;

FIG. 5(a) is a curve diagram showing changes in the included angle θ of the rotation gesture of the present invention; FIG. 5(b) is a curve diagram showing changes in the included angle α of the rotation gesture of the present invention;

FIG. 6 is a curve diagram showing changes in the included angle α of the gesture of turning upside down of the present invention;

FIG. 7 is a structural schematic diagram of a system for a smart cup for performing command control via gesture of the present invention.

### DETAILED DESCRIPTION OF THE INVENTION

As shown in FIG. 1, a smart cup comprises a cup body 110 and a main board 120.

The main board 120 is provided on a bottom of the cup body 110 and is provided with a tilt angle sensor 121 and a control unit 122. The tilt angle sensor 121 and the control unit 122 are connected.

The tilt angle sensor 121 detects an included angle between the smart cup and a vertical direction and an included angle between the smart cup and a horizontal direction respectively, and sends data about the included angles to the control unit 122. A corresponding gesture manipulating the cup body 110 can be recognized according to the changes in the included angles.

The control unit 122 is used for calculating changes in the angles according to the data about the included angles, recognizing a corresponding gesture according to the changes in the angles, and matching and executing a corresponding command according to the gesture recognized.

The smart cup of the present invention can perform command control via a gesture.

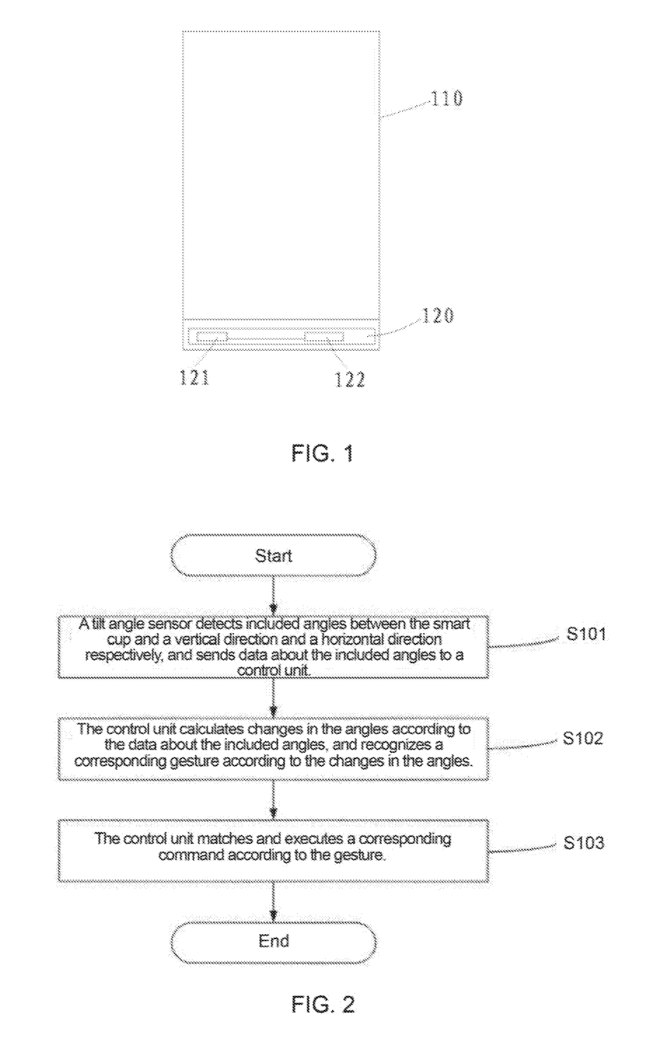

As shown in FIG. 2, the present invention also relates to a method for a smart cup for performing command control via gesture, comprising:

S101, as shown in FIG. 3, a tilt angle sensor 121 detects an included angle θ between the smart cup and a vertical direction and an included angle α between the smart cup and a preset horizontal reference line L in real time, and sends data about the included angles to a control unit 122.

S102, the control unit 122 calculates changes in the angles according to the data about the included angles, and recognizes a corresponding gesture according to the changes in the angles, which specifically includes:

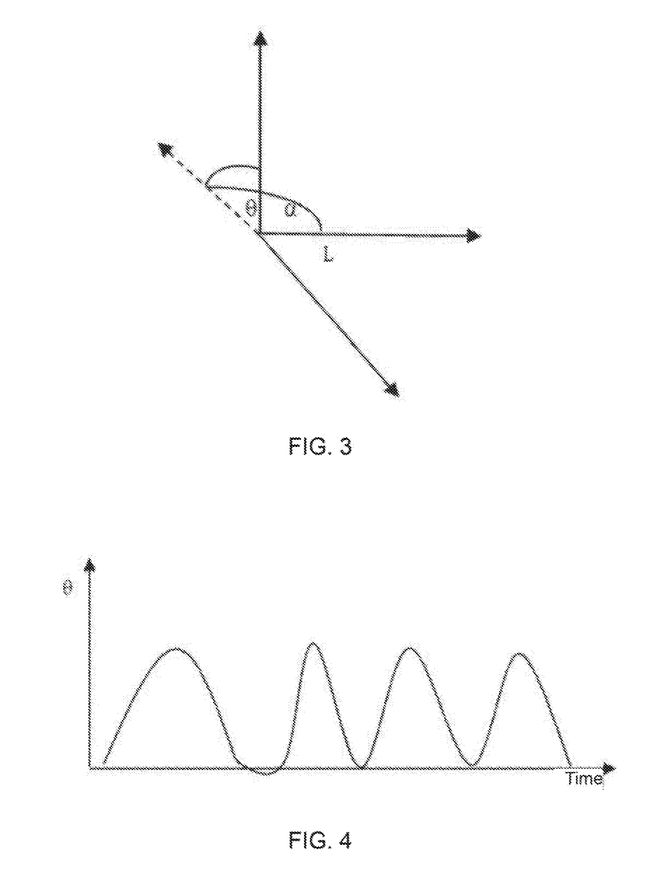

As shown in FIG. 4, if the included angle θ shows a regular wave-shaped pattern, the corresponding gesture is horizontal shaking of the cup.

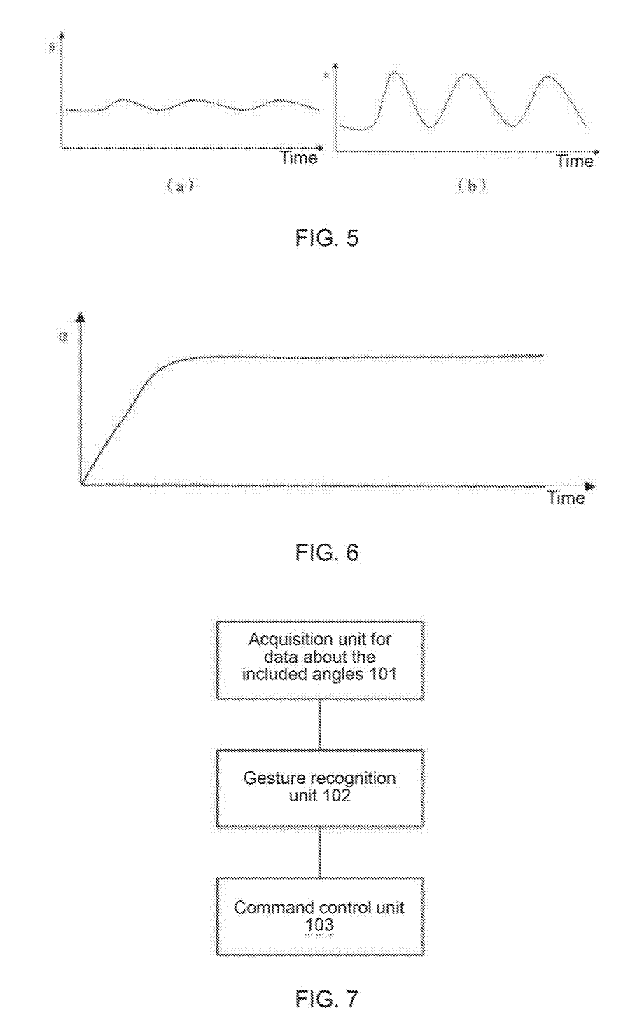

As shown in FIGS. 5(a) and (b), if the angle θ is always maintained at an angle and the included angle α shows a regular wave-shaped pattern, the corresponding gesture is rotation of the cup, that is, using wrist to move the cup in a cone direction.

As shown in FIG. 6, if the included angle α is always maintained at 270 degrees, the corresponding gesture is turning of the cup upside down. Alternatively, this gesture can be identified if the included angle θ is always maintained at 180 degrees.

S103, the control unit 122 matches and executes a corresponding command according to the gesture.

Wherein, corresponding data of the gestures and commands are stored in the control unit 122.

Specifically, the horizontal shaking gesture can correspond to triggering of a device, or triggering of a specific function, such as the function of recognition of triggering gesture, or switching off of a specific function such as mandatory termination of the communication connection and reconnection.

The rotation gesture can correspond to activating transmission, or connecting WIFI AP, or switching WIFI state such as from listening state to transmitting state.

The gesture of turning upside down can correspond to mandatory entering of the sleep mode of the cup, or functions such as clearing of water amount statistics.

Certainly, the above-mentioned gestures are not limited to the above-mentioned functions.

The present invention, by taking changes in included angles between the smart cup and a vertical direction as well as between the smart cup and a horizontal direction as a basis for recognizing a gesture, enabling different gestures to match different commands, and controlling the smart cup via a command, realizes interaction between an individual and the cup.

As shown in FIG. 7, the present invention further relates to a system for a smart cup for performing command control via gesture, comprising:

An acquisition unit for data about the included angles 101, as shown in FIG. 3, for detecting an included angle θ between the smart cup and a vertical direction and an included angle α between the smart cup and a preset horizontal reference line L in real time by the tilt angle sensor 121, and sending data about the included angles to the control unit 122;

A gesture recognition unit 102 for calculating changes in the angles according to the data about the included angles and recognizing a corresponding gesture according to the changes in the angles by the control unit 122, which specifically includes:

As shown in FIG. 4, if the included angle θ shows a regular wave-shaped pattern, the corresponding gesture is horizontal shaking of the cup.

As shown in FIGS. 5(a) and (b), if the angle θ is always maintained at an angle and the included angle α shows a regular wave-shaped pattern, the corresponding gesture is rotation of the cup, that is, using wrist to move the cup in a cone direction.

As shown in FIG. 6, if the included angle α is always maintained at 270 degrees, the corresponding gesture is turning of the cup upside down. Alternatively, this gesture can be identified if the included angle θ is always maintained at 180 degrees.

A command control unit 103 for matching and executing a corresponding command according to the gesture by the control unit 122.

Wherein, corresponding data of the gestures and commands are stored in the control unit 122.

Specifically, the horizontal shaking gesture can correspond to triggering of a device, or triggering of a specific function, such as the function of recognition of triggering gesture, or switching off of a specific function such as mandatory termination of the communication connection and reconnection.

The rotation gesture can correspond to activating transmission, or connecting WIFI AP, or switching WIFI state such as from listening state to transmitting state.

The gesture of turning upside down can correspond to mandatory entering of the sleep mode of the cup, or functions such as clearing of water amount statistics.

Certainly, the above-mentioned gestures are not limited to the above-mentioned functions.

The present invention, by taking changes in included angles between the smart cup and a vertical direction as well as between the smart cup and a horizontal direction as a basis for recognizing a gesture, enabling different gestures to match different commands, and controlling the smart cup via a command, realizes interaction between an individual and the cup.

However, it should be understood by those of ordinary skill in the art that the foregoing embodiments are intended to be illustrative of the invention, and they do not imply any limitations on the invention described and claimed herein. All modifications and variations made to the foregoing embodiments within the spirit or scope of the invention are included within the scope of the invention as defined by the following claims.

We claim:

1. A smart cup, characterized in that it comprises a cup body and a main board on a bottom of the cup body and is provided with a tilt angle sensor and a control unit; the tilt angle sensor and the control unit are connected.

2. A method for the smart cup as in claim 1 for performing command control via gesture, characterized in that it comprises:
the tilt angle sensor detects an included angle θ between the smart cup and a vertical direction and an included angle α between the smart cup and a preset horizontal reference line in real time, and sends data about the included angles to the control unit;
the control unit calculates changes in the angles according to the data about the included angles, and recognizes a corresponding gesture according to the changes in the angles;
the control unit matches and executes a corresponding command according to the gesture.

3. The method for a smart cup for performing command control via gesture as in claim 2, characterized in that the corresponding gesture recognized according to the changes in the angles comprising:
if the included angle θ shows a regular wave-shaped pattern, the corresponding gesture is horizontal shaking of the cup;
if the included angle θ is always maintained at an angle and the included angle α shows a regular wave-shaped pattern, the corresponding gesture is rotation of the cup;
if the included angle α is always maintained at 270 degrees, the corresponding gesture is turning of the cup upside down.

4. The method for a smart cup for performing command control via gesture as in claim 2 or 3, characterized in that corresponding data of the gestures and commands are stored in the control unit.

5. A system for a smart cup for performing command control via gesture, characterized in that it comprises:
an acquisition unit for data about the included angles for detecting an included angle θ between the smart cup and a vertical direction and an included angle α between the smart cup and a horizontal direction in real time by a tilt angle sensor, and sending data about the included angles to a control unit;
a gesture recognition unit for calculating changes in the angles according to the data about the included angles and recognizing a corresponding gesture according to the changes in the angles by the control unit;
a command control unit for matching and executing a corresponding command according to the gesture by the control unit.

6. The system for a smart cup for performing command control via gesture as in claim 5, characterized in that the corresponding gesture recognized according to the changes in the angles comprising:
if the included angle θ shows a regular wave-shaped pattern, the corresponding gesture is horizontal shaking of the cup;
if the included angle θ is always maintained at an angle and the included angle α shows a regular wave-shaped pattern, the corresponding gesture is rotation of the cup;
if the included angle α is always maintained at 270 degrees, the corresponding gesture is turning of the cup upside down.

7. The system for a smart cup for performing command control via gesture as in claim 5 or 6, characterized in that corresponding data of the gestures and commands are stored in the control unit.
